(19) United States
(12) Patent Application Publication
(10) Pub. No.: US 2015/0144680 A1
(43) Pub. Date: May 28, 2015

(54) Method of Making Cooking Vessel with Heat Conduction

(71) Applicant: Yao-Tsung Kao, Tainan City (TW)

(72) Inventor: Yao-Tsung Kao, Tainan City (TW)

(21) Appl. No.: 14/088,495

(22) Filed: Nov. 25, 2013

(51) Int. Cl. B23K 20/12; A47J 27/022; A47J 27/00

(52) U.S. Cl. CPC B23K 20/129; A47J 27/002; A47J 27/022
USPC 228/114.5

(57) ABSTRACT

A cooking vessel is made of metal material and includes a vessel body. The vessel body has a heat conducting disc made of aluminum material. A method of making the cooking vessel contains steps of: precast molding the heat conducting disc so as to y form a plurality of ribs or circular grooves which facilitate heating after placing the cooking vessel on a stove and heating the cooking vessel by ways of the stove; clamping a vessel bottom and the heat conducting disc by using a mold on a friction welding machine and rotating the heat conducting disc; pushing the heat conducting disc toward the vessel bottom; friction welding the heat conducting disc with the vessel bottom. Thereby, the vessel bottom and the heat conducting disc are one piece formed securely.

### FIELD OF THE INVENTION

The present invent relates to a method of making a cooking vessel with heat conduction which one piece forms a vessel bottom and a heat conducting disc of a vessel body securely.

### BACKGROUND OF THE INVENTION

Referring to FIG. 1, a conventional cooking vessel contains a vessel body 10, and the vessel body 10 has a heating plate 101 fixed on a bottom end thereof. It is to be noted that the vessel body 10 and the heating plate 101 are made of different metal materials. For example, the vessel body 10 is made of stainless steel, but an outer peripheral side of the heating plate 101 is made of aluminum material, an inner portion of the heating plate 101 has an aluminum plate covered therein. However, the heating plate 101 cannot heat the cooking vessel efficiently. In addition, the heating plate is flat and smooth, so it cannot be clamped by a mold on a friction welding machine fixedly. In other words, the heating plate 101 and the vessel body 10 cannot friction welded together.

Referring further to FIG. 2, another conventional cooking vessel contains a vessel body 1. The vessel body 1 has a heating disc 11 mounted on a bottom end thereof, and the heating disc 11 has a plurality of circular grooves defined thereon and a flat face friction stamped with the bottom end of the vessel body 1. Furthermore, the bottom end of the heating disc 11 has a plurality of metal ribs 111 radially arranged thereon, and between any two adjacent metal ribs 111 are defined a plurality of first metal wings 112 and second metal wings 113, wherein a length of each first metal wing 112 is different from that of each second metal wing 113. The plurality of metal ribs 111, first metal wings 112, and second metal wings 113 are fixed together in a brazing step (high frequency waves) 43, such that the heating disc 11 has a plurality of orifices 110 formed around a peripheral side thereof. Nevertheless, the plurality of metal ribs 111, first metal wings 112, and second metal wings 113 cannot be fixed by ways of a friction stamping.

Thereby, the vessel body is produced complicatedly and expensively. Moreover, a structural strength of the vessel body is poor, thus breaking and deforming the cooking vessel easily.

The present invention has arisen to mitigate and/or obviate the afore-described disadvantages.

### SUMMARY OF THE INVENTION

The primary object of the present invention is to provide a cooking vessel with heat conduction which one piece forms a vessel bottom and a heat conducting disc of a vessel body securely.

A cooking vessel is made of metal material and includes a vessel body. The vessel body has a heat conducting disc made of aluminum material.

In a first embodiment, a method of making the cooking vessel contains steps of:

precast molding the heat conducting disc so as to directly form a plurality of ribs or circular grooves which facilitate heating after placing the cooking vessel on a stove and heating the cooking vessel by ways of the stove;

clamping a vessel bottom and the heat conducting disc by using a mold on a friction welding machine and rotating the heat conducting disc;

pushing the heat conducting disc toward the vessel bottom;

friction welding the heat conducting disc with the vessel bottom.

In a second embodiment, a method of making the cooking vessel contains steps of:

pot welding a vessel bottom and an aluminum plate of the vessel body;

preheating the vessel bottom and the aluminum plate by ways of a brazing so as to soften the vessel bottom and the aluminum plate;

fixing the vessel bottom and the aluminum plate on a friction stamping machine by using a mold;

spirally rotating the mold at a high speed so as to connect the vessel bottom and the aluminum plate together;

molding the aluminum plate so as form a heat conducting disc with a plurality of ribs or circular grooves which are pre-molded.

### BRIEF DESCRIPTION OF THE DRAWINGS

FIG. 1 is a cross sectional view of a conventional cooking vessel.

FIG. 2 is a perspective view of another conventional cooking vessel.

FIG. 3 is a flow chart of a method of making a cooking vessel with heat conduction according to a first embodiment of the present invention.

FIG. 4 is a flow chart of a method of making a cooking vessel with heat conduction according to a second embodiment of the present invention.

FIG. 5 is a plan view showing a vessel body being friction welded with a heat conducting disc according to the first embodiment of the present invention.

FIG. 6 is another plan view showing the vessel body being friction welded with the heat conducting disc according to the first embodiment of the present invention.

FIG. 7 is also another plan view showing the vessel body being friction welded with the heat conducting disc according to the first embodiment of the present invention.

FIG. 8 is a perspective view showing the assembly of the heat conducting disc according to the present invention.

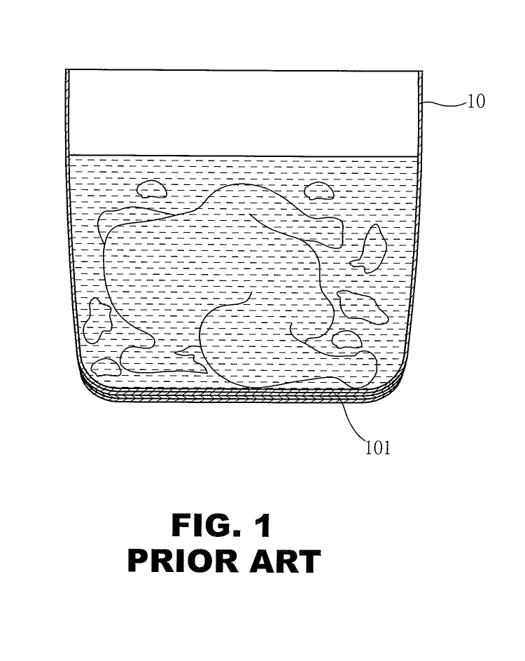

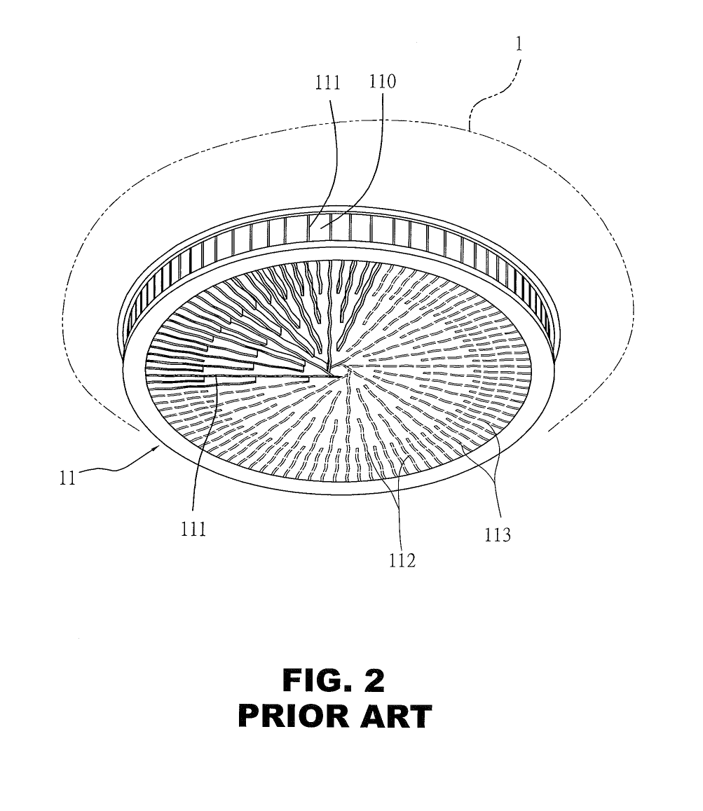

### DETAILED DESCRIPTION OF THE PREFERRED EMBODIMENTS

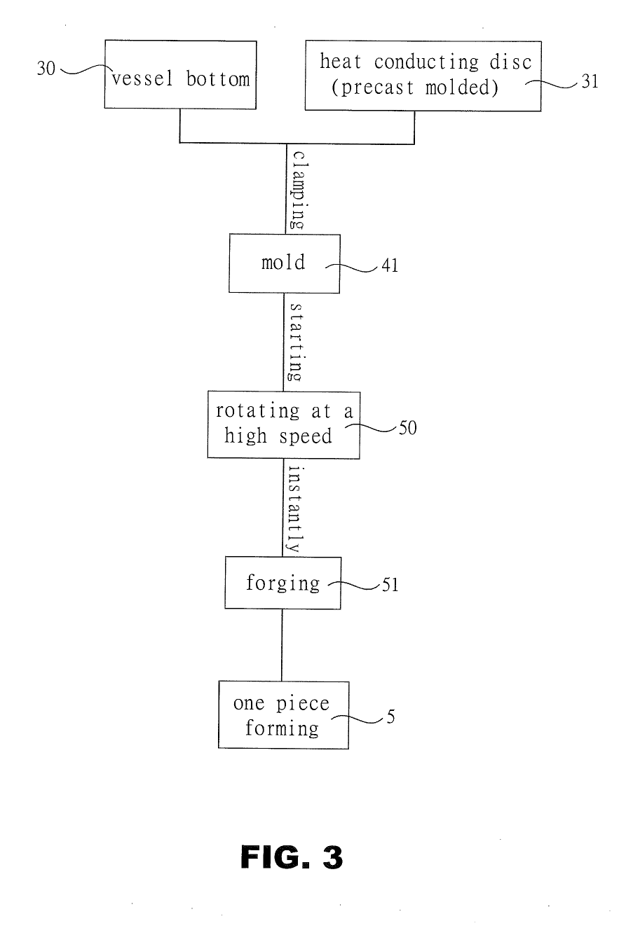

FIG. 3 is a flow chart of a method of making a cooking vessel with heat conduction according to a first embodiment of the present invention. A cooking vessel is made of metal material (such as stainless steel) and is any one of a frying pan, a stockpot and a teapot. The cooking vessel includes a vessel body, and the vessel body has a heat conducting disc 31 precast molded from aluminum material so as to form a plurality of ribs or circular grooves which facilitate heating after placing the cooking vessel on a stove and heating the cooking vessel by ways of the stove. As desiring to friction weld a vessel bottom 30 with the heat conducting disc 31, the vessel bottom 31 and the heat conducting disc 31 are clamped by a mold 41 on a friction welding machine, and the heat conducting disc 31 is rotated in a high-speed rotation step 50 and is pushed toward the vessel bottom 30, then the heat conducting disc 31 is friction welded with the vessel bottom 30 at a high temperature (around 600-700° C.). In the meantime, the vessel bottom 30 (made of stainless steel) does not reach a melting point, but it is soften and causes a capillary dilation at the high temperature. After a rotation of the mold 41 is stopped and the heat conducting disc 31 is separated a distance from the vessel bottom 30, the heat conducting disc 31 is stamped toward the vessel 30 at a high speed, such that the heat conducting disc 31 is penetrated into the vessel bottom 30, thereafter the heat conducting disc 31 is connected with the vessel bottom 30 in a forging step 51, thus one piece forming the vessel bottom 30 and the heat conducting disc 31 securely.

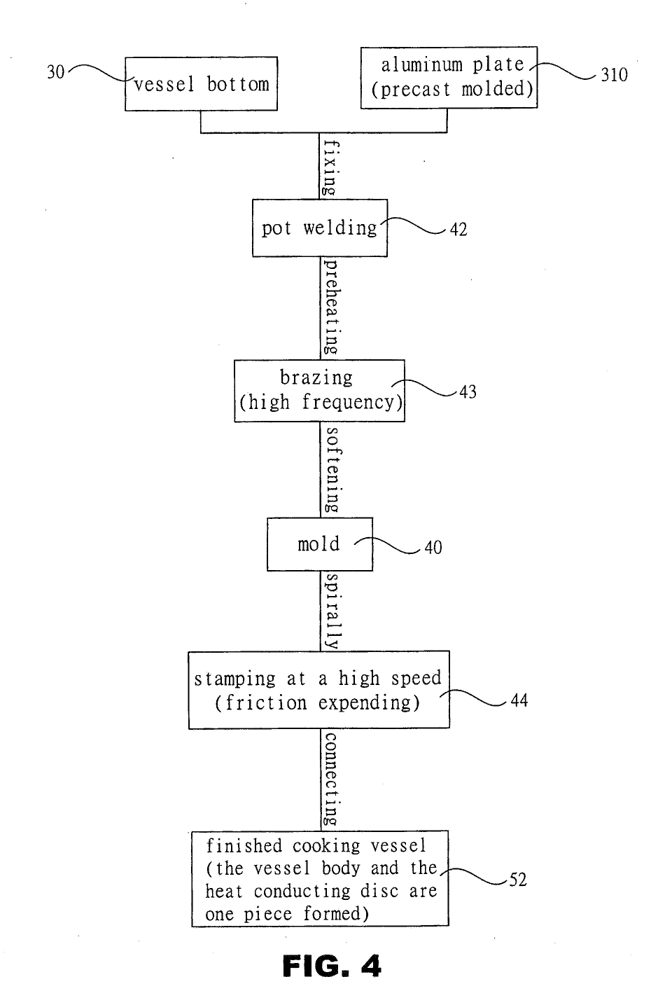

FIG. 4 is a flow chart of a method of making a cooking vessel with heat conduction according to a second embodiment of the present invention. A cooking vessel is made of metal material (such as stainless steel) and is any one of a frying pan, a stockpot and a teapot. The cooking vessel includes a vessel body, and the vessel body has an aluminum plate 310 for heating the cooking vessel 30 on a stove quickly. The vessel bottom 30 and the aluminum plate 310 are fixed in a spot welding step 42, and they are preheated in a brazing (high frequency wave) step 43 so that a temperature of the vessel bottom 30 and the aluminum plate 310 reaches up to 400° C., such that two surfaces of the vessel bottom 30 and the aluminum plate 310 are soften. Thereafter, the vessel bottom 30 and the aluminum plate 310 are fixed by a mold 40 on a friction stamping machine. By spirally rotating the mold 40 in a speedy stamping step 44, the vessel bottom 30 and the aluminum plate 310 are connected together. The aluminum plate 310 is molded by the mold 40 so as to from a heat conducting disc with a plurality of ribs or circular grooves which are pre-molded, thereby producing the heat conducting disc. Accordingly, the vessel body and the heat conducting disc are one piece formed so as to produce a finished cooking vessel 52. The cooking vessel is reinforced strongly so as to prolong its service life. In addition, the plurality of ribs or circular grooves of the heat conducting disc are friction stamped with the vessel bottom 30 and the aluminum plate 310 fixedly.

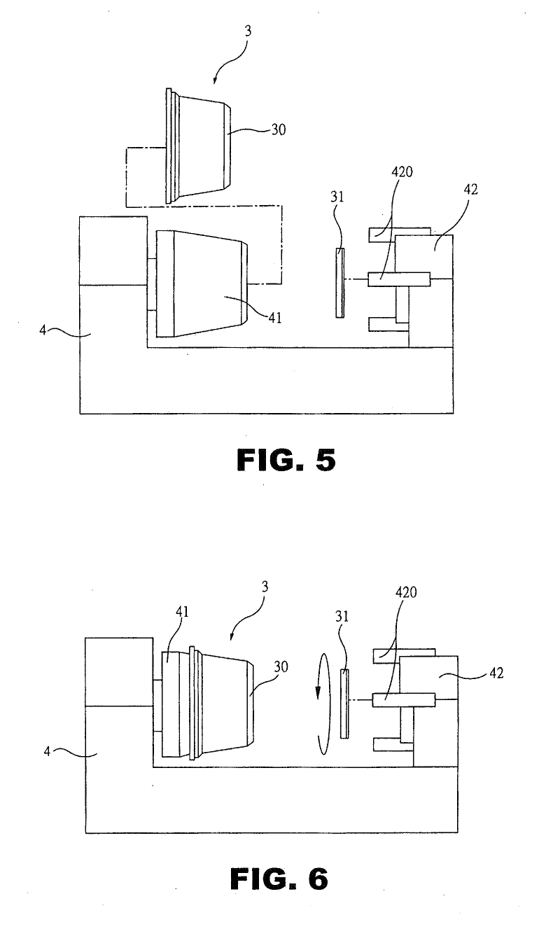

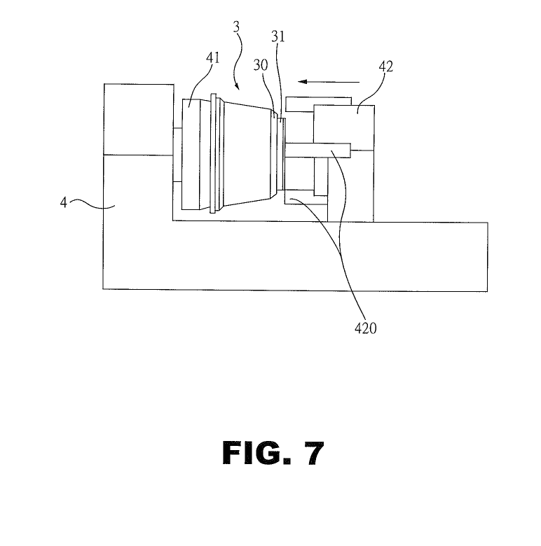

FIG. 5 is a plan view showing the vessel body 3 being friction welded with the heat conducting disc 31 according to the first embodiment of the present invention. The vessel body 3 is clamped by the mold 41 on the friction welding machine 4, and a jaw 420 of a rotating seat 42 of the heat welding machine 4 retains the heat conducting disc 31 (as shown in FIG. 6), wherein the heat conducting disc 31 has the plurality of ribs or circular grooves, so the jaw 42 expends its clamping feet to retain the plurality of ribs or circular grooves, and the heat conducting disc 31 is separated a distance from the vessel body 3, The heat conducting disc 31 is rotated at the high speed and is pushed toward to the vessel bottom 30, then the heat conducting disc 31 is friction welded with the vessel bottom 30 at the high temperature (around 600-700° C.). In the meantime, the vessel bottom 30 (made of stainless steel) does not reach the melting point, but it is soften and causes the capillary dilation at the high temperature. After a rotation of the mold 41 is stopped and the heat conducting disc 31 is separated a distance from the vessel bottom 30, and then the heat conducting disc 31 is stamped toward the vessel 30 at the high speed (as illustrated in FIG. 7), such that the heat conducting disc 31 is penetrated into the vessel bottom 30, thereafter the heat conducting disc 31 is connected with the vessel bottom 30 in the forging 51 step, thus one piece forming the vessel bottom 30 and the heat conducting disc 31 securely.

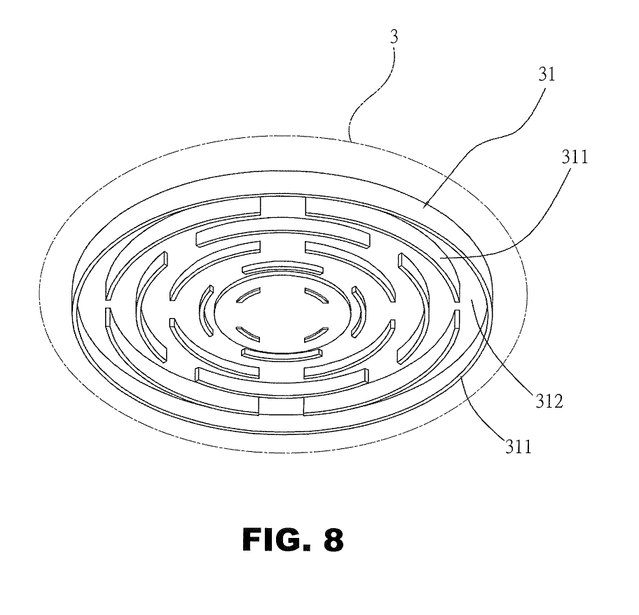

FIG. 8 is a perspective view showing the assembly of the heat conducting disc 31. The heat conducting disc 31 is precast molded or stamped from aluminum material so as to form the plurality of ribs and is one piece formed with the vessel body 3, wherein each rib 311 is provided to facilitate heating, and the heat conducting disc 31 is reinforced strongly so as to prevent from deformation and damage, thus prolonging service life. Furthermore, between any two adjacent ribs 311 are defined a plurality of circular grooves 312 so as to enhance heating efficiency. Preferably, the heat conducting disc 31 is friction welded or friction stamped with the vessel body so as to produce the cooking vessel easily.

Moreover, the aluminum plate is friction stamped with the vessel body by using the mold, thus simplifying brazing (high frequency wave) and decreasing production cost.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A method of making a cooking vessel with heat conduction, a cooking vessel made by a method being made of metal material and including a vessel body, the vessel body having a heat conducting disc made of aluminum material, and the method comprising steps of:
precast molding the heat conducting disc so as to form a plurality of ribs or circular grooves which facilitate heating after placing the cooking vessel on a stove and heating the cooking vessel by ways of the stove;
clamping a vessel bottom and the heat conducting disc by using a mold on a friction welding machine and rotating the heat conducting disc;
pushing the heat conducting disc toward the vessel bottom;
friction welding the heat conducting disc with the vessel bottom.

2. A method of making a cooking vessel with heat conduction, a cooking vessel made by a method being made of metal material and including a vessel body, the vessel body having a heat conducting disc made of aluminum material, and the method comprising steps of:
pot welding a vessel bottom and an aluminum plate of the vessel body;
preheating the vessel bottom and the aluminum plate by ways of a brazing so as to soften the vessel bottom and the aluminum plate;
fixing the vessel bottom and the aluminum plate on a friction stamping machine by using a mold;
spirally rotating the mold at a high speed so as to connect the vessel bottom and the aluminum plate together;
molding the aluminum plate so as form the heat conducting disc with a plurality of ribs or circular grooves which are pre-molded.
